(19) United States
(12) Patent Application Publication
(10) Pub. No.: US 2007/0154248 A1
(43) Pub. Date: Jul. 5, 2007

(54) Duplex scanning device having a rotatable scanning unit and duplex scanning method thereof

(75) Inventor: Yen-Cheng Chen, Hsin Chu City (TW)

Correspondence Address: BIRCH STEWART KOLASCH & BIRCH, PO BOX 747, FALLS CHURCH, VA, 22040-0747, US

(73) Assignee: Avision Inc.

(21) Appl. No.: 11/645,494

(22) Filed: Dec. 27, 2006

(30) Foreign Application Priority Data
Jan. 5, 2006 (TW) 095100412

(51) Int. Cl. G03G 15/00

(52) U.S. Cl. 399/374

(57) ABSTRACT

A duplex scanning device includes a casing, a transporting mechanism, a scanning unit and a scanning unit rotating mechanism. The transporting mechanism transports a sheet along a transporting passageway, which includes a front passageway, a middle passageway and a rear passageway. The scanning unit rotatably mounted on the casing scans the sheet in the middle passageway. The transporting mechanism transports the sheet from the front passageway to the rear passageway through the middle passageway so that the scanning unit scans a front side of the sheet. Then, the scanning unit rotating mechanism rotates the scanning unit by substantially 180 degrees. Next, the transporting mechanism transports the sheet from the rear passageway to the front passageway through the middle passageway so that the scanning unit scans a back side of the sheet.

### BACKGROUND OF THE INVENTION

1. Field of Invention

The invention relates to a duplex scanning device and a duplex scanning method thereof, and more particularly to a duplex scanning device having a rotatable scanning unit, and a duplex scanning method thereof.

2. Related Art

A conventional duplex scanning device usually has two optical modules for respectively scanning a front side and a back side of a document. Because the cost of the optical module is higher, the price of the duplex scanning device cannot be reduced.

Another conventional duplex scanning device only has a single optical module. However, the document has to be transported thrice and turned twice by a document transporting mechanism so that the front side and the back side of the document can be scanned. For example, the document transporting mechanism first transports the document at the first time so that the optical module can scan the front side of the document. Then, the document transporting mechanism turns the document at the first time through a turning passageway so that the optical module can scan the back side of the document. Next, the document transporting mechanism turns the document at the second time again through the turning passageway so that the order of a stack of documents can be kept unchanged after the duplex scanning processes. However, the document turning passageway and mechanism are usually very complicated, and occupy a relatively large space. So, the cost of the duplex scanning device also cannot be effectively reduced.

Thus, it is an important subject of the invention to provide a duplex scanning device capable of performing a duplex scanning process conveniently with the lower cost and the smaller size.

### SUMMARY OF THE INVENTION

It is therefore an object of the invention to provide a duplex scanning device having a rotatable scanning unit and a duplex scanning method thereof. The duplex scanning effect can be achieved effectively by rotating the scanning unit.

To achieve the above-identified object, the invention provides a duplex scanning device including a casing, a transporting mechanism, a scanning unit and a scanning unit rotating mechanism. The transporting mechanism is mounted in the casing and transports a sheet along a transporting passageway, which comprises a front passageway, a rear passageway and a middle passageway connecting the front passageway to the rear passageway. The scanning unit is rotatably mounted in the casing and scans the sheet in the middle passageway. The scanning unit rotating mechanism rotates the scanning unit. The transporting mechanism transports the sheet from the front passageway to the rear passageway through the middle passageway so that the scanning unit scans a front side of the sheet. Next, the scanning unit rotating mechanism rotates the scanning unit by substantially 180 degrees. Then, the transporting mechanism transports the sheet from the rear passageway to the front passageway through the middle passageway so that the scanning unit scans a back side of the sheet.

The invention also provides a duplex scanning method including the steps of: transporting a sheet from a front passageway to a rear passageway through a middle passageway, while scanning a front side of the sheet in the middle passageway; rotating a scanning unit by substantially 180 degrees; and transporting the sheet from the rear passageway to the front passageway through the middle passageway, while scanning a back side of the sheet in the middle passageway.

Thus, it is possible to provide a duplex scanning device capable of performing a duplex scanning process conveniently with the lower cost and the smaller size.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIGS. 1 and 2 are schematic illustrations showing two states of a duplex scanning device according to a first embodiment of the invention;

FIG. 3 is a schematic illustration showing a scanning unit of a duplex scanning device according to a second embodiment of the invention;

FIG. 4 is a schematic illustration showing a scanning unit of a duplex scanning device according to a third embodiment of the invention; and

FIG. 5 is a flow chart showing a duplex scanning method according to a fourth embodiment of the invention.

### DETAILED DESCRIPTION OF THE INVENTION

The present invention will be apparent from the following detailed description, which proceeds with reference to the accompanying drawings, wherein the same references relate to the same elements.

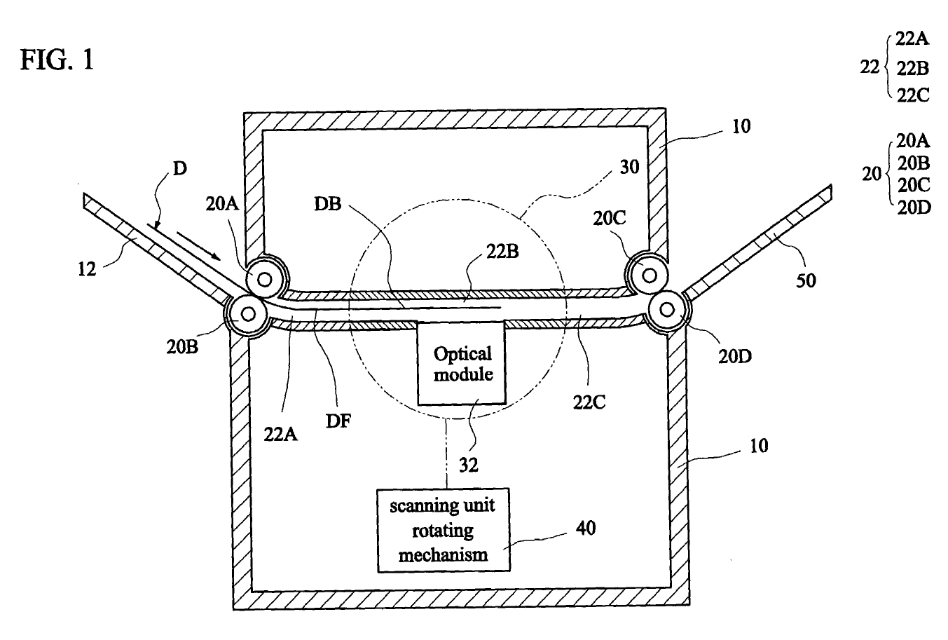

FIGS. 1 and 2 are schematic illustrations showing two states of a duplex scanning device according to a first embodiment of the invention. Referring to FIGS. 1 and 2, the duplex scanning device of the first embodiment includes a casing 10, a sheet input tray 12, a transporting mechanism 20 mounted in the casing 10, a scanning unit 30 rotatably mounted in the casing 10, a scanning unit rotating mechanism 40 for rotating the scanning unit 30, and a sheet output tray 50.

The transporting mechanism 20 includes a plurality of transporting rollers 20A to 20D. It is to be noted that the transporting rollers 20A to 20D may also be replaced with a plurality of transporting belts. The transporting mechanism 20 transports a sheet D along a transporting passageway 22. The transporting passageway 22 includes a front passageway 22A, a rear passageway 22C and a middle passageway 22B connecting the front passageway 22A to the rear passageway 22C.

In this embodiment, the scanning unit 30 is an optical module 32, which may be a charge coupled device (CCD) optical module or a contact image sensor (CIS) optical module for acquiring an image of the sheet D. The scanning unit 30 scans the sheet D in the middle passageway 22B. The scanning unit rotating mechanism 40 rotates the scanning unit 30 preferably in a reversible manner so as to prevent the trouble of wiring.

When the duplex scan is being performed, the transporting mechanism 20 transports the sheet D from the front passageway 22A to the rear passageway 22C through the middle passageway 22B so that the scanning unit 30 can scan a front side DF of the sheet D. Then, the scanning unit rotating mechanism 40 rotates the scanning unit 30 by substantially 180 degrees. Next, the transporting mechanism 20 transports the sheet D from the rear passageway 22C to the front passageway 22A through the middle passageway 22B so that the scanning unit 30 scans a back side DB of the sheet D.

After the back side DB has been scanned, the transporting mechanism 20 may transport the sheet D from the front passageway 22A to the sheet output tray 50, which is connected to the rear passageway 22C, through the middle passageway 22B and the rear passageway 22C. Thus, the sheet output tray 50 can accommodate the sheet D outputted from the rear passageway 22C.

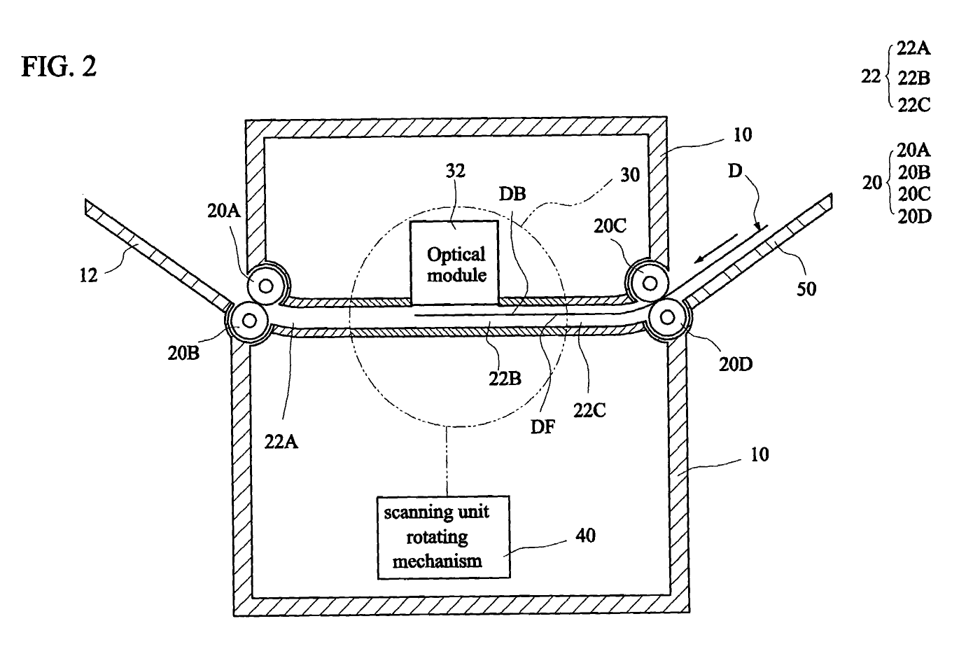

FIG. 3 is a schematic illustration showing a scanning unit of a duplex scanning device according to a second embodiment of the invention. As shown in FIG. 3, the scanning unit 30′ of this embodiment differs from the scanning unit 30 of the first embodiment in that the scanning unit 30′ includes an optical module 32 and a pressing roller 34. The pressing roller 34 can be rotated to press the sheet D against the optical module 32, and the optical module 32 acquires the image of the sheet D.

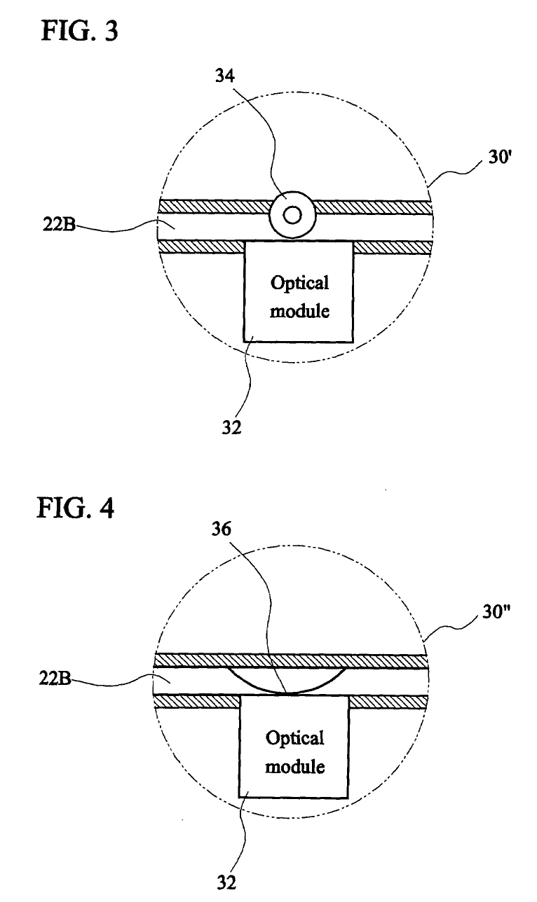

FIG. 4 is a schematic illustration showing a scanning unit of a duplex scanning device according to a third embodiment of the invention. As shown in FIG. 4, the scanning unit 30″ of this embodiment differs from the scanning unit 30 of the first embodiment in that the scanning unit 30″ includes an optical module 32 for acquiring the image of the sheet D, and an elastic sheet 36 for pressing the sheet D against the optical module 32.

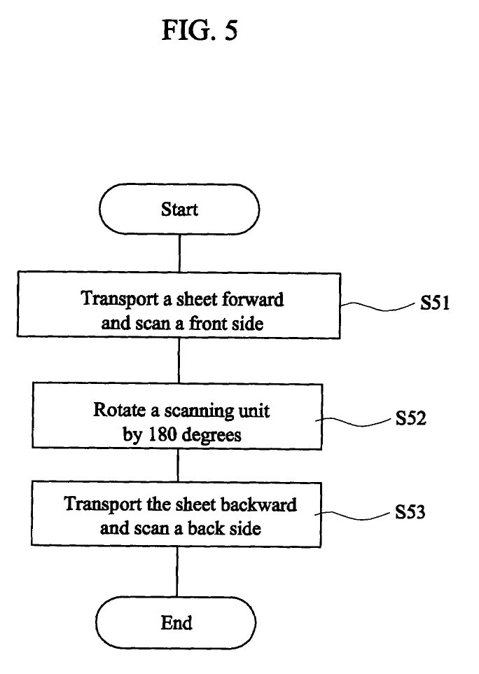

FIG. 5 is a flow chart showing a duplex scanning method according to a fourth embodiment of the invention. Referring to FIGS. 5, 1 and 2, the duplex scanning method of the invention includes the following steps.

In step S51, the sheet is transported forwards while the front side of the sheet is scanned. That is, the sheet D is transported from the front passageway 22A to the rear passageway 22C through the middle passageway 22B, while the front side DF of the sheet D is scanned in the middle passageway 22B.

In step S52, the scanning unit 30 is rotated by substantially 180 degrees.

In step S53, the sheet is transported backwards while the back side of the sheet is scanned. That is, the sheet D is transported from the rear passageway 22C to the front passageway 22A through the middle passageway 22B, while the back side DB of the sheet D is scanned in the middle passageway 22B.

As shown in the above-mentioned embodiment, after the back side DB has been scanned, the sheet D can be transported from the front passageway 22A to the sheet output tray 50 through the middle passageway 22B and the rear passageway 22C.

Alternatively, after the back side DB has been scanned, the sheet D can be transported from the front passageway 22A to the sheet input tray 12.

When a stack of sheets is being scanned, first all of the front sides of the sheets are scanned, the scanning unit is then rotated by 180 degrees, and at last the back sides of the sheets are scanned. Alternatively, it is also possible to scan the front side of one sheet first, the scanning unit is then rotated, and then the back side of the sheet is scanned. The sheet, after being scanned, is transported to the sheet output tray or to another sheet accommodating means through another passageway.

Thus, with the rotatable scanning unit installed, the duplex scanning device can effectively carry out the duplex scan operation. The scanning unit can be configured to have a substantially circular structure in order to save the occupied space. It is also possible to dispose other electrical components in the scanning unit in order to prevent the wastage of the space. The effect of the invention can be effectively achieved as long as the middle passageway can effectively connect the front passageway to the rear passageway after the scanning unit is rotated by 180 degrees. Thus, since the invention does not have to adopt two optical modules and the passageways and mechanism for turning over the sheet, the size and the production cost of the scanning device may be reduced.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A duplex scanning device, comprising:
a casing;
a transporting mechanism, which is mounted in the casing, for transporting a sheet along a transporting passageway, which comprises a front passageway, a rear passageway and a middle passageway connecting the front passageway to the rear passageway;
a scanning unit, which is rotatably mounted in the casing, for scanning the sheet in the middle passageway; and
a scanning unit rotating mechanism for rotating the scanning unit, wherein the transporting mechanism transports the sheet from the front passageway to the rear passageway through the middle passageway so that the scanning unit scans a front side of the sheet, the scanning unit rotating mechanism rotates the scanning unit by substantially 180 degrees, and then the transporting mechanism transports the sheet from the rear passageway to the front passageway through the middle passageway so that the scanning unit scans a back side of the sheet.

2. The device according to claim 1, wherein the transporting mechanism comprises a plurality of transporting rollers.

3. The device according to claim 1, wherein the transporting mechanism comprises a plurality of transporting belts.

4. The device according to claim 1, wherein the scanning unit is an optical module for acquiring an image of the sheet.

5. The device according to claim 1, wherein the scanning unit comprises an optical module and a pressing roller, the pressing roller can be rotated to press the sheet against the optical module, and the optical module acquires an image of the sheet.

6. The device according to claim 1, wherein the scanning unit comprises an optical module for acquiring an image of the sheet, and an elastic sheet for pressing the sheet against the optical module.

7. The device according to claim 1, further comprising:
a sheet output tray, which is connected to the rear passageway, for accommodating the sheet outputted from the rear passageway.

8. A duplex scanning method, comprising the steps of:
transporting a sheet from a front passageway to a rear passageway through a middle passageway, while scanning a front side of the sheet in the middle passageway;
rotating a scanning unit by substantially 180 degrees; and
transporting the sheet from the rear passageway to the front passageway through the middle passageway, while scanning a back side of the sheet in the middle passageway.

9. The method according to claim 8, further comprising the step of:
transporting the sheet from the front passageway to a sheet output tray through the middle passageway and the rear passageway after the back side has been scanned.

10. The method according to claim 8, further comprising the step of:
transporting the sheet from the front passageway to a sheet input tray after the back side has been scanned.
